(19) United States
(12) Patent Application Publication
(10) Pub. No.: US 2014/0361041 A1
(43) Pub. Date: Dec. 11, 2014

(54) Modular Valve Array Having A Single Dispense Point

(71) Applicant: CORNELIUS, INC., ST. PAUL, MN (US)

(72) Inventor: Phil C. Hawken, Darien, IL (US)

(73) Assignee: CORNELIUS, INC., ST. PAUL, MN (US)

(21) Appl. No.: 14/253,614

(22) Filed: Apr. 15, 2014

Related U.S. Application Data
(60) Provisional application No. 61/832,599, filed on Jun. 7, 2013.

(51) Int. Cl. B67D 7/74

(52) U.S. Cl. CPC B67D 1/0085; B67D 2001/0094
USPC 222/129.1

(57) ABSTRACT

The invention relates to a valve dispensing system that can be used in a beverage dispenser. In particular, the valve dispensing system has individual valve module components that control the flow of a beverage or beverage component, and a plurality of valve module components may be combined to form a system capable of dispensing a plurality of beverages and/or beverage components.

This Application claims the benefit of the filing date under 35 U.S.C. §119(e) of U.S. Provisional Application No. 61/832,599, filed on Jun. 7, 2013, which is hereby incorporated by reference in its entirety.

### BACKGROUND OF THE INVENTION

1. Field of the Invention

The present invention relates generally to the field of beverage dispensers, and more particularly to a modular valve assembly in which an array of valve modules are connected to a manifold for dispensing multiple different beverages through a single nozzle dispense point.

2. Summary of the Invention

The present invention relates to a valve assembly for dispensing multiple beverages through a single nozzle dispense point. One aspect of the invention recognizes the need for a modular valve assembly that can easily be expanded to allow more types of beverages to be dispensed. A valve module has multiple fluid pathways and a flow control and shut-off component for controlling the flow of fluid through each pathway. A manifold is configured to receive at least one valve module, but may also be configured to receive multiple valve modules. Valve modules can easily be added to the manifold to expand the dispensing capacity of the valve assembly. The manifold also contains pathways for directing the fluid to a diffuser, which releases the fluid into a single nozzle dispense point.

### DESCRIPTION OF THE FIGURES

FIG. 1 is a side perspective view of a valve module having two fluid pathways.

FIG. 2 is a top perspective view of a manifold.

FIG. 3 is a side perspective of a valve module, manifold, and nozzle connected to each other.

FIG. 4 shows a seal, syrup tips, diffuser and nozzle.

FIG. 5 shows an array of valve modules positioned within a housing.

### DETAILED DESCRIPTION OF THE INVENTION

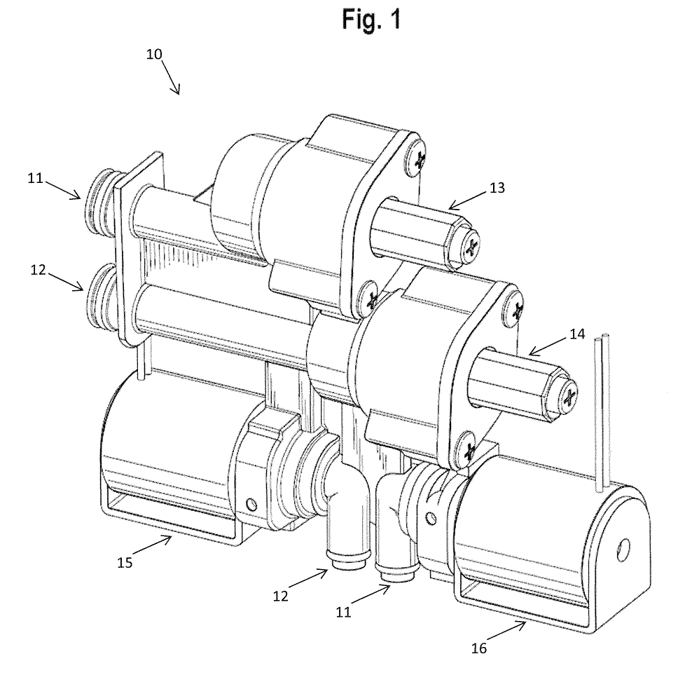

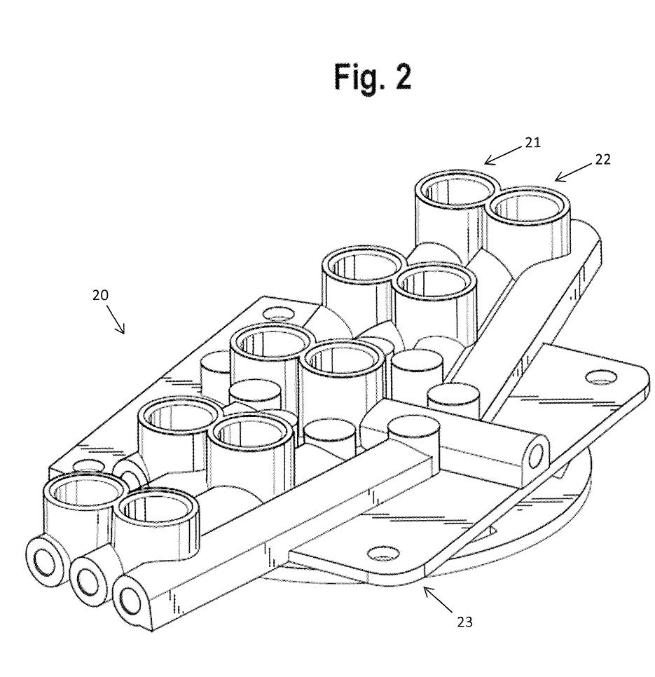

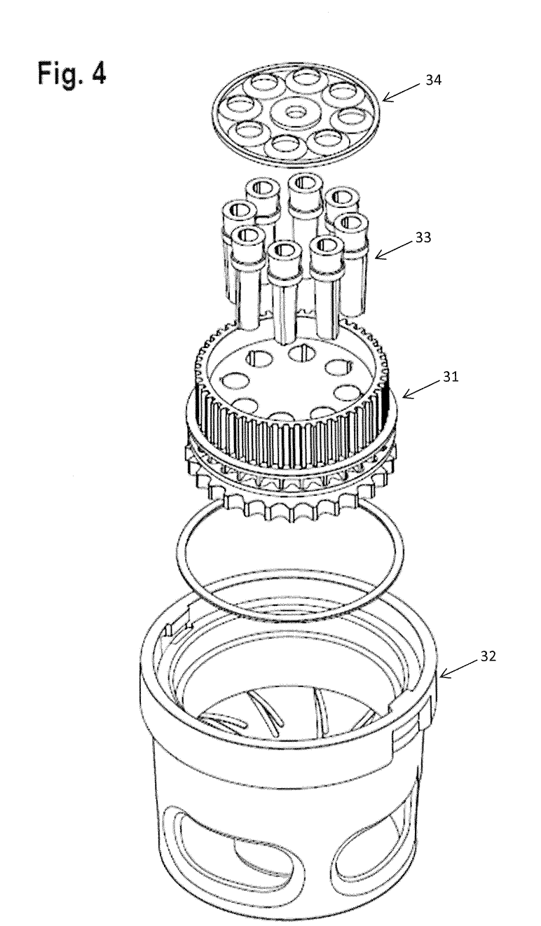

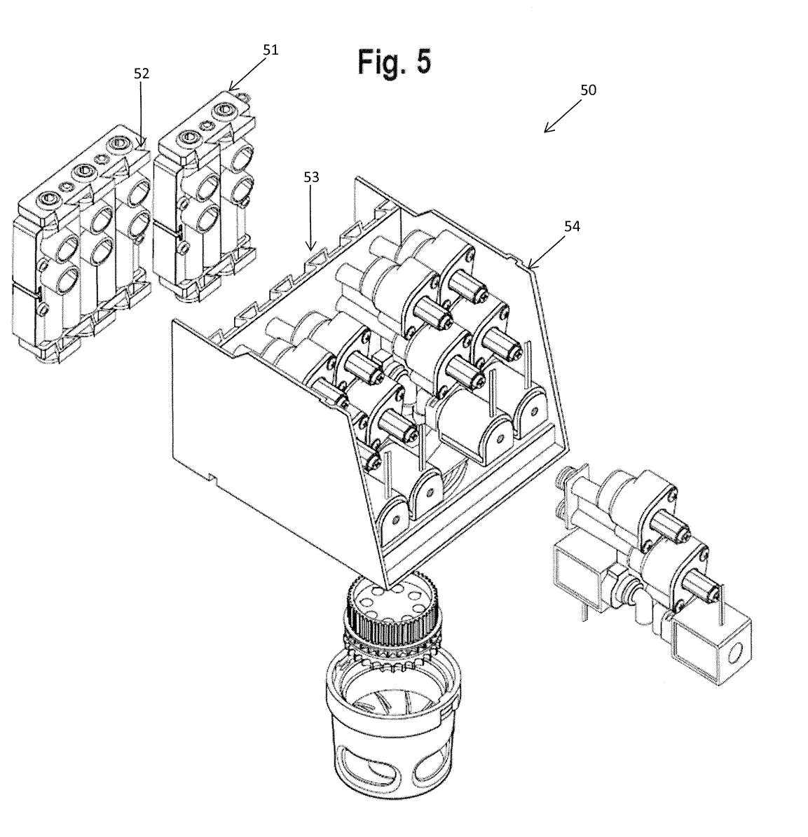

Referring now to the drawings, FIGS. 1-5 show an embodiment of the valve assembly. The valve assembly 50, as in FIG. 5, uses one or more valve modules 10, as seen for example in FIG. 1, to create an expandable array of valves capable of dispensing different beverages. Valve module 10 contains fluid pathways 11, 12, that may be interfaced to a manifold 20. When a valve module 10 is connected to the manifold 20, the fluid pathway(s) 11, 12 of the valve module 10 interface with a corresponding pathway in the manifold 21, 22. The manifold 20 and manifold pathways 21 and 22 are show in greater detail in FIG. 2. In this way, a fluid may travel through a fluid pathway 11, 12 in the valve module 10 and into the corresponding pathway of the manifold 21, 22, which routes the fluid to a common dispense point 23. At the common dispense point 23, a diffuser 31 (as seen for example in FIG. 4) diffuses the fluid into a nozzle 32, where the fluid may mix with other fluids to create a beverage. Flow control 13, 14 and shut-off components 15, 16 in the valve module control the amount of fluid that flows through the pathways. Although valve module 10 in FIG. 1 is shown having two sets of fluid pathways 11, 12, it is understood that each valve module 10 may have any number of pathways.

Referring specifically to FIG. 1, the valve module 10 is shown as having two separate fluid pathways 11, 12. The fluid pathways 11, 12 are not in communication with each other. Each fluid pathway 11, 12 is controlled by a shut-off component 15, 16 and a flow control component 13, 14. Together, the shut-off component 15, 16 and the flow control component 13, 14 control the rate (or completely stop the flow) of a fluid flowing through the fluid pathways 11, 12. Although the shut-off component 15, 16 and the flow control components 11, 12 are shown separately in the embodiment of FIG. 1, it is also possible for a single component to control both the flow and the shut-off of a pathway.

In one embodiment, the shut-off component 15, 16 may be a solenoid designed to be ¼ turn twist on, which requires no tools to remove, install, or service. The solenoid may use a 24v DC direct pull and plunger assembly, but alternatively a “hit and hold” solenoid using electronic controls could also be used. For the flow-control component, a differential pressure ceramic flow control may be used. In an alternate embodiment, the flow-control component may include stepper motor rotary controls that function on flow feedback.

The fluid pathways 11, 12 are configured to interface with a manifold 20 (see FIG. 2) on one end, and with a backblock 51 (see FIG. 5) on the other end. The backblock 51 provides fluid which may flow through the fluid pathways 11, 12 when the shut-off component 15, 16 and flow control component 13, 14 are in the open position. The backblock 51 may contain an interface to a fluid source. The backblock 51 may further include a heat exchanger for controlling the temperature of a fluid. An example thereof is disclosed in Applicant's U.S. Pat. App. 61/831,517, which is hereby incorporated in its entirety. The backblock 51 may be fastened to the housing using mating “dove-tail” fasteners 52, 53 as see in FIG. 5. More specifically, FIG. 5 shows a dovetail 52 on the backblock, and a mating receptacle 53 on the housing. Using mating dove-tail features to connect the housing to the backblock provides the added benefit being easily detachable for cleaning.

The fluid flowing from the backblock 51 into the valve module(s) 10 may be a branded beverage, or the fluid may be a beverage component, such as a syrup, concentrate, water, or carbonated water. The embodiment of FIG. 1 shows a valve module 10 having two fluid pathways 11, 12. But, a valve module 10 may have any number of fluid pathways. An advantage of using two fluid pathways per valve module is the ability to closely match the number of valves required by adding or removing valve modules.

Optionally, one or more of the valve modules may be in electronic communication with a CPU. Via the electronic communication, the CPU may be able to control either the valve module's shut off component and/or its flow control, thereby allowing the CPU to effectively control the volume and/or rate at which each of the valve modules dispenses a beverage. The valve modules may be controlled by a CPU, which receives a beverage recipe and drink size through an input, such as a touch screen or a conventional button, and operates the relevant valve modules 10 to dispense the required amount of each fluid. In other words, each valve module 10 contains a component of a beverage, and the CPU may operate the valve module(s) 10 to dispense the correct amount of each beverage component required to construct a beverage. The CPU may be in communication with a computer readable memory that uses non-transitory memory to store data representative of a beverage recipe. Thus, the CPU knows the correct amount of each beverage component that must be dispensed to construct a beverage. The CPU controls the opening and closing of the flow-control components 13, 14 of each valve module 10. Thus, the CPU may open any desired combination of valves for a predetermined time period to dispense the required quantity of each fluid.

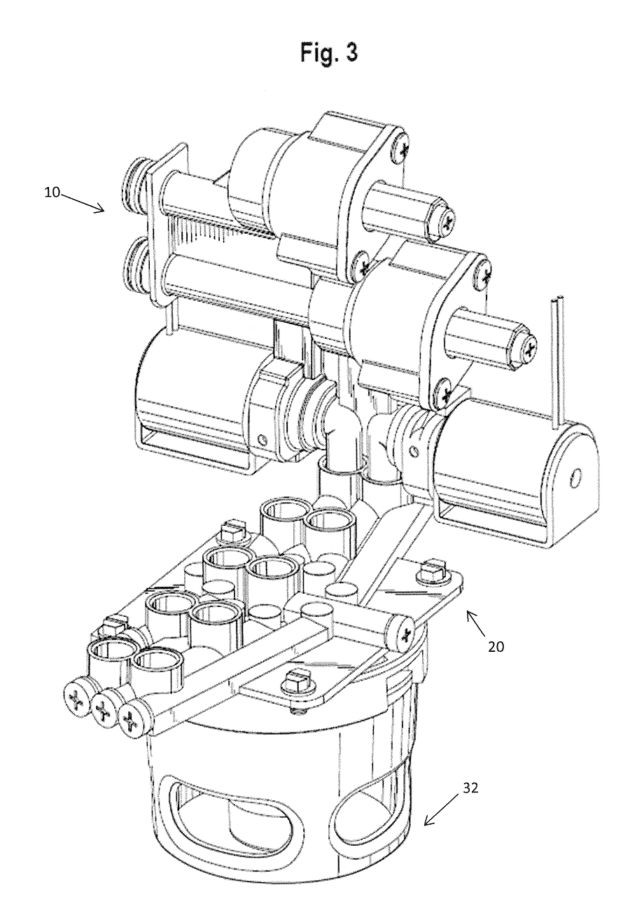

FIG. 2 shows a manifold 20 which interfaces with the valve module 10. In FIG. 3, a manifold 20 and a valve module 10 are shown in the interfaced configuration. The manifold 20 used in this embodiment has five sets of two fluid pathways. Each set of these manifold pathways interfaces with the valve module fluid pathways when a valve module 10 is connected to the manifold. Thus, the manifold of FIG. 2 is capable of interfacing with five valve modules, where each valve module has two fluid pathways. It is understood that the manifold may be configured to receive any number of valve modules. Likewise, the housing 54 shown in FIG. 5 is configured to hold five valve modules, but may also be expanded according to a user's needs.

The manifold pathways 21, 22 direct fluid to a common dispense point 23. In the embodiment of FIG. 2, the common dispense point 23 is positioned near the center of the manifold, but alternate configurations are also possible. Moreover, it is preferable, but not necessary, that each manifold pathway 21, 22 have a slight downward slope from valve module interface to the common dispense point. A downward-sloping manifold pathway takes advantage of gravity to help move fluid to the common dispense point.

The manifold pathways 21, 22 of FIG. 2 are not in fluid communication with each other. It is envisioned that the fluid pathways 11, 12 of the valve module 10, and by extension the manifold pathways 21, 22, can carry different flavored beverages or beverage components. Separating the manifold pathways 21, 22 ensures that cross-contamination does not occur. Although there may be instances in which it is desirable to mix multiple beverages or beverages components (i.e. mixing a cherry concentrate with a cola beverage, or mixing a cola concentrate with carbonated water), the embodiment of FIG. 2 contemplates that such mixing should preferably occur in the nozzle.

In alternative embodiments, a subset of the manifold pathways 21, 22 may be in fluid communication with each other. For example, it may be desirable to create a common manifold pathway that mixes uncarbonated water and carbonated water to create a mid-carbonated water.

At the common dispense point 23, the manifold pathways 21, 22 open into a diffuser 31. The diffuser 31 is shown in FIG. 4. The diffuser 31 is designed to cause fluids to disperse into the nozzle 32. The various ridges and edges shown in the diffuser 31 of FIG. 4 have the effect of causing fluid to disperse evenly in the nozzle. The diffuser 31 provides the advantage of causing an even distribution of the fluid into the nozzle, which is beneficial because it enhances the mixing of multiple fluids. For example, where a cola and a cherry flavor are mixed in the nozzle 32, the diffuser 31 enhances the mixing of the fluids. Similarly, the diffuser 31 enhances the mixing of beverage syrup or concentrate with water or carbonated water. In the embodiment of FIG. 3, the diffuser 31 is designed to flow up to 4 ounces of water per second.

Moreover, syrup tips 33 (shown in FIG. 4) may be used to guide fluid from the manifold pathways 21, 22 into the diffuser 31. The use of syrup tips 33 provides the added benefit of reducing backsplash, and thus reducing the possibility of cross-contamination. Similarly, a seal 34 may be used to reduce potential leakage. In one embodiment, the seal 34 is a face-sealing silicon seal, which is easier to clean than typical 0-ring and bore type assemblies.

FIG. 3 shows a valve module 10 and a nozzle 32 mounted to the manifold 20. In operation, the valve module 10 and manifold 32 may be placed in a housing (not shown). Additional valve modules may be attached to the manifold in order to expand the dispense capability of the valve assembly.

What is claimed is:

1. A modular valve assembly for dispensing multiple beverages through a single dispense point, comprising:
at least one valve module, the valve module having at least two fluid pathways, wherein each of the fluid pathways has a flow control component and a shut-off component for controlling flow of a fluid through the fluid pathway;
a manifold configured to receive the at least one valve module, the manifold further comprising at least two manifold pathways configured to interface with the at least two fluid pathways of the valve module and receive the fluid from the fluid pathways, wherein the at least two manifold pathways are further configured to deliver the fluid to a diffuser; and
a nozzle for dispensing fluid attached to the diffuser.

2. The modular valve assembly of claim 1, wherein the shut-off components are a ¼ turn twist-on solenoid.

3. The modular valve assembly of claim 2, wherein the solenoid is a 24V DC direct pull and plunger assembly.

4. The modular valve assembly of claim 2, wherein the solenoid is a hit-and-hold solenoid having electronic controls.

5. The modular valve assembly of claim 1, further comprising a CPU in electronic communication with each shut-off component.

6. The modular valve assembly of claim 5, further comprising a computer readable memory in electronic communication with the CPU, the computer readable memory containing data representative of at least one beverage recipe.

7. An expandable valve assembly for dispensing multiple beverages through a single nozzle, comprising:
a housing having at least one valve module, a manifold, a diffuser, and a nozzle;
at least one fluid pathway formed in the valve module, the fluid pathway having a first opening and a second opening; and
at least one manifold pathway formed in the manifold, the manifold pathway having a first opening and a second opening;
wherein the first opening of the fluid pathway is interfaced with a backblock, the second opening of the fluid pathway is interfaced with the first opening of the manifold pathway, the second opening of the fluid pathway is interfaced with the diffuser, and the diffuser is in fluid communication with the nozzle.

8. The expandable valve assembly of claim 7, further comprising a flow control component and shut-off component for each fluid pathway.

9. The expandable valve assembly of claim 8, further comprising a CPU in electronic communication with each shut-off component and with a non-transitory computer readable memory.

10. The expandable valve assembly of claim 9, wherein the non-transitory computer readable memory contains data representative of at least one beverage recipe.

11. The expandable valve assembly of claim 7, further comprising at least one dove-tail attachment member attached to the housing.

12. The expandable valve assembly of claim 11, wherein the dove-tail attachment member is configured to interface with a back-block.
